(19) United States
(12) Patent Application Publication
(10) Pub. No.: US 2012/0229730 A1
(43) Pub. Date: Sep. 13, 2012

(54) LIQUID CRYSTAL DISPLAY

(75) Inventors: Dong Pyo KIM, Daejeon (KR); Kyu Ha Baek, Daejeon (KR)

(73) Assignee: Electronics and Telecommunications Research Institute, Daejeon (KR)

(21) Appl. No.: 13/413,617

(22) Filed: Mar. 6, 2012

(30) Foreign Application Priority Data
Mar. 9, 2011 (KR) 10-2011-0020907

(51) Int. Cl. G02F 1/13357

(52) U.S. Cl. 349/64; 349/62

(57) ABSTRACT

Disclosed is a liquid crystal display including: a liquid crystal panel; and a backlight unit disposed below the liquid crystal panel and irradiating light to the liquid crystal panel, in which the backlight unit includes a reflective layer increasing an amount of light irradiated to the liquid crystal panel.

### CROSS-REFERENCE TO RELATED APPLICATIONS

This application is based on and claims priority from Korean Patent Application No. 10-2011-0020907, filed on Mar. 9, 2011, with the Korean Intellectual Property Office, the disclosure of which is incorporated herein in its entirety by reference.

### TECHNICAL FIELD

The present disclosure relates to a liquid crystal display, and more particularly, to a liquid crystal display which reflects light absorbed into a black matrix to a reflective plate of the bottom of a light guide plate by using a reflective layer to change a path of light and transmit the light to an opening region of a color filter layer, that is, a light transmitting region of a liquid crystal panel again by forming the reflective layer having the same region as or a larger region than the black matrix of the color filter layer in a backlight unit, thereby minimizing the loss of light and increasing an amount of light to acquire high luminance.

### BACKGROUND

Recently, demands for energy reduction and a realistic video have increased in a market and as a result, techniques for low power consumption, high image quality, and a large size of a flat panel display device have been actively developed. A liquid crystal display (LCD) among various flat panel display devices has a simple driving circuit, a thin film, low power consumption, and high image quality, such that the liquid crystal display is used for a large-size flat panel TV, a computer monitor, a screen of a portable device, and the like. In general, the liquid crystal display is a device for displaying desired data by separately supplying data signals to data lines of color filters layer arranged in a predetermined form to control a liquid crystal arrangement and control an amount of light transmitting the color filter layers. Since the liquid crystal display does not self-emit light, a backlight unit irradiating the light from the rear thereof is required.

FIG. 1 is a cross-sectional view illustrating a schematic configuration of a general liquid crystal display.

Referring to FIG. 1, the liquid crystal display includes a liquid crystal panel 101 including a color filter layer 112 arranged in a predetermined form and a backlight unit 102 irradiating light to the liquid crystal panel 101. A color filter substrate 113 including a black matrix 111 and the color filter layer 112 and a TFT array substrate 123 including a plurality of thin film transistors 122 and a pixel electrode face each other in the liquid crystal panel 101. The color filter substrate 113 and the TFT array substrate 123 are bonded with each other while maintaining a regular interval with a spacer and a sealing member 117 and a liquid crystal layer 116 is interposed in a separated space.

Although not shown in FIG. 1, a single pixel area is defined by a gate line and a data line of the TFT array substrate 123 and a thin film transistor 122 is included in each pixel. The pixel electrode is formed at the TFT array substrate 123, a common electrode 115 is formed at the color filter substrate 113, and an alignment layer 121 for aligning liquid crystal molecules of the liquid crystal layer 116 is coated on each of the TFT array substrate 123 and the color filter substrate 113. On the color filter substrate 113, the black matrix 111 for blocking the light inputted above the region of the thin film transistor 122 formed on the TFT array substrate 123 and preventing light leakage from occurring at the boundary of the color filter layer 112 and the color filter layer 112 for actually implementing colors are formed. Upper and lower polarizers 124 and 136 polarizing the light irradiated from the backlight unit 102 are disposed above and below the liquid crystal panel 101.

Meanwhile, since the liquid crystal display is a device of displaying an image by controlling the transmittance of light, the backlight unit 102 for irradiating the light to the liquid crystal panel 101 is disposed at the bottom of the liquid crystal panel 101. In the backlight unit 102, a light source 131 is disposed on one side of a light guide plate 133, a reflective plate 132 is disposed on the bottom of the light guide plate 133, an optical sheet in which a diffusion sheet 134 and a prism sheet 135 are stacked is disposed on the upper surface of the light guide plate 133. Accordingly, after the light irradiated from the light source 131 is collected in the light guide plate 133 to pass through the diffusion sheet 134 and the prism sheet 135 which are optical sheets, as shown in an arrow of FIG. 1, only the light L₁ transmitted to a light transmitting region Sop of the liquid crystal panel 101, that is, an opening region of the color filter substrate 113 displays data or images on the screen.

However, in a general liquid crystal display of a color filter type, light L₁+L₂ emitted from the light source 131 to pass through the light guide plate 133 and then, be irradiated to the liquid crystal panel is almost absorbed in a process of passing through a pair of TFT array substrates 123, a configuration layer of the color filter substrate 113, the liquid crystal layer, the polarizer, and the like or blocked in a black matrix region S_{bm} of the color filter substrate 113, that is, a light blocking region to be dissipated like the light L₂. Accordingly, finally, an amount of the light L₁ emitted from the surface of the liquid crystal is no more than about 5 to 10% of the amount of light of an initially inputted light source, such that light efficiency was much deteriorated.

Meanwhile, in US Patent Application Laid-Open No. 2006/0092347 (Korean Patent Application Laid-Open No. 10-2006-0027221), disclosed is that a reflective layer having the same pattern as a black matrix or a single reflective layer substrate is formed on the bottom of the TFT array substrate, such that the light irradiated to the black matrix of the color filter substrate is reflected to change a path of light and the light is transferred to a light transmitting region of the liquid crystal again, thereby finally increasing the amount of light transmitting the light transmitting region. However, in US Patent Application Laid-Open No. 2006/0092347, there is a disadvantage in that while the light is reflected on the polarizer to pass through the reflective plate of the backlight unit, the light is scattered or absorbed at the polarizer and the optical sheet of the backlight unit, such that the loss of light occurs and an improving effect of the light efficiency is low.

In Korean Patent No. 10-0658085, disclosed is that polarizing patterns vertical to a transmitting axis of lower and upper polarizers are formed by using a resin black matrix, such that the color filter has an excellent optical density (OD) value even in a black matrix having a thin thickness. Accordingly, in Korean Patent No. 10-0658085, since the thickness of the black matrix is thin, a defect caused by a rubbing defect and the like is reduced and the OD value is high, such that the quality of the liquid crystal display is improved. However, in Korean Patent No. 10-0658085, there are disadvantages in that materials of the resin black matrix having the polarizer are limited and it is difficult to form the polarizing patterns vertical to a transmitting axis of the polarizer.

### SUMMARY

The present disclosure has been made in an effort to provide a liquid crystal display, in which light irradiated to a light guide plate is blocked by a black matrix while passing through a liquid crystal panel by adding a reflective layer in an optical sheet of a back light unit or below or in a lower polarizer, such that a loss amount of light is minimized and as a result, an amount of light passing through a light transmitting region of a liquid crystal is increased, thereby acquiring high light efficiency and high luminance.

The present disclosure has been made in another effort to provide a liquid crystal display capable of reducing a thickness of a black matrix by having a high OD value even in the thin black matrix by blocking the light irradiated to the black matrix.

The present disclosure has been made in another effort to provide a liquid crystal display having high light efficiency and high luminance by improving a step of a color filter by the reduced thickness of the black matrix, reducing an amount of light absorbed in the color filter by reducing a thickness of an overcoating layer, and accordingly, increasing an amount of light passing through an opening region of the liquid crystal panel.

The present disclosure has been made in another effort to provide a liquid crystal display capable of reducing a defect such as a rubbing defect due to a pixel step to improve productivity and reduce costs by using a thin black matrix or removing a black matrix.

An exemplary embodiment of the present disclosure provides a liquid crystal display including: a liquid crystal panel; and a backlight unit disposed below the liquid crystal panel and irradiating light to the liquid crystal panel, in which the backlight unit includes a reflective layer increasing an amount of light irradiated to the liquid crystal panel.

According to exemplary embodiments of the present disclosure, by providing a liquid crystal display in which the reflective layer having the same region as or a larger region than the black matrix is formed at an optical sheet of a backlight unit or a lower polarizer, a path of the light lost in a black matrix of a color filter layer is changed by using a reflective layer and as a result, an amount of light passing through a light transmitting region of a liquid crystal panel is increased, such that it is possible to acquire high luminance.

According to exemplary embodiments of the present disclosure, by providing a liquid crystal display in which the reflective layer having the same region as or a larger region than the black matrix is formed at an optical sheet of a backlight unit or a lower polarizer, a thickness of a black matrix of a color filter layer becomes thinner or the black matrix is removed, such that it is possible to reduce a step of the color filter layer and as a result, a thickness of an overcoating layer for flatness becomes thinner or the overcoating layer is removed, such that absorptance of light in the color filter layer is reduced to improve transmittance of light. The black matrix having the thin thickness may reduce a rubbing defect of an alignment layer process, such that productivity can increase and costs can be reduced.

According to exemplary embodiments of the present disclosure, by providing a liquid crystal display adding a reflection function of light by including reflective patterns which are vertical to a transmitting axis of a lower polarizer, it is possible to improve light efficiency. Herein, the lower polarizer having the reflective patterns may be fabricated by applying a known process as it is.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a cross-sectional view illustrating a schematic configuration of a general liquid crystal display.

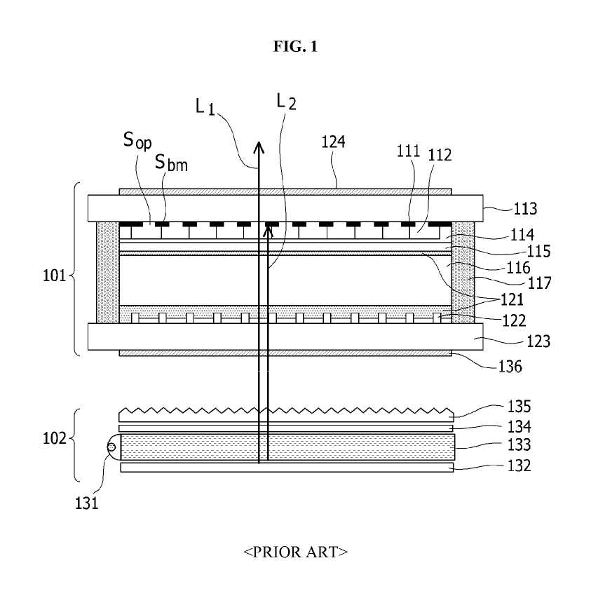

FIG. 2 is a cross-sectional view illustrating a schematic configuration of a liquid crystal display according to a first exemplary embodiment of the present disclosure.

FIG. 3 is a cross-sectional view illustrating a schematic configuration of a liquid crystal display according to a second exemplary embodiment of the present disclosure.

FIG. 4 is a cross-sectional view illustrating a schematic configuration of a liquid crystal display according to a third exemplary embodiment of the present disclosure.

FIG. 5 is a cross-sectional view illustrating a schematic configuration of a liquid crystal display according to a fourth exemplary embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

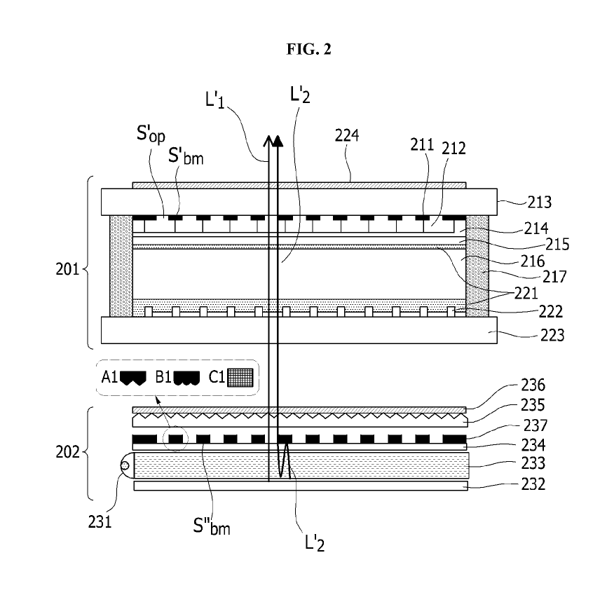

FIG. 2 is a cross-sectional view illustrating a schematic configuration of a liquid crystal display according to a first exemplary embodiment of the present disclosure.

Referring to FIG. 2, a liquid crystal panel 201 includes a color filter substrate 213 and a TFT array substrate 223 which face each other and bonded with each other while maintaining a predetermined cell gap and a liquid crystal layer 216 interposed in a separated space of the color filter substrate 213 and the TFT array substrate 223.

A plurality of pixels defined by a gate line and a data line are formed on the TFT array substrate 223 and a driving element such as a thin film transistor (TFT) 222 is formed in each pixel. On the color filter substrate 213, a black matrix 211 generating a light blocking region S′_{bm} and a color filter layer 212 for actually implementing colors are formed, in which the light blocking region S′_{bm} prevents light from being leaked above the regions of the gate line, the data line, and the thin film transistor 222 formed on the TFT array substrate 223. A pixel electrode and a common electrode 215 are formed on each of the color filter substrate 213 and the TFT array substrate 223 and an alignment layer 221 for aligning liquid crystal molecules of the liquid crystal layer 216 is coated thereon.

In this case, the liquid crystal panel 201 may be an IPS mode liquid crystal display in which both the common electrode and the pixel electrode are formed on the TFT array substrate 223.

The black matrix 211 is formed in a region on the color filter substrate 213 corresponding to the regions of the gate line, the data line, and the thin film transistor to define the light blocking region S′_{bm} in the liquid crystal panel 201.

In this case, the black matrix 211 may be made of a metallic material such as chromium (Cr) or a chromium oxide (CrOx), but in the case where the black matrix 211 is applied to an in-plain switching (IPS) mode liquid crystal display in which both the common electrode and the pixel electrode are formed on the TFT array substrate 223, since the metallic component of the black matrix may influence the in-plain switching between the two electrodes (that is, the common electrode and the pixel electrode), the black matrix 211 may also use a resin film made of a black resin instead of the metallic component.

The color filter substrate 213 and the TFT array substrate 223 are bonded with each other by a sealing member 217 and an upper polarizer 224 polarizing the light inputted from the backlight unit 202 is formed above the liquid crystal panel 201.

Meanwhile, since the liquid crystal display according to the exemplary embodiment of the present disclosure is a device for displaying an image by controlling the transmittance of light, the backlight unit 202 for irradiating the light to the liquid crystal panel 201 is disposed at the bottom of the liquid crystal panel 201. Herein, the backlight unit 202 includes a light source 231, a reflective plate 232, a light guide plate 233, a diffusion sheet 234, a reflective layer 237, a prism sheet 235, and a lower polarizer 236.

The light source 231 is formed at one side of the light guide plate 233 to generate the light.

The reflective plate 232 is formed below the light guide plate 233 to change a path of light inputted through the reflective layer 237.

The light guide plate 233 collects the light irradiated from the light source 231.

The diffusion sheet 234 is formed above the light guide plate 233 to acquire uniform luminance according to a viewing angle.

The reflective layer 237 is formed above the diffusion sheet 234 to reflect the light emitted from the light guide plate 233 to the reflective plate 232, thereby changing a path of light. That is, the light irradiated from the light source 231 is collected in the light guide plate 233 to pass through the diffusion sheet 234 which is an optical sheet and then, be irradiated to the black matrix region S′_{bm} of the color filter substrate 213. Light L′₂ irradiated to the black matrix region S′_{bm} of the color filter substrate 213 is reflected toward the light guide plate 233 and the reflective plate 232 of the bottom thereof from a light blocking region S″_{bm} of the reflective layer 237 and the path thereof is changed and then, the Light L′₂ is collected in the light transmitting region S′ₒₚ of the liquid crystal panel 201. As a result, the lights transmitting the liquid crystal panel 201 are L′₁ and L′₂, such that the amount of light of the liquid crystal display may increase and high luminance may be acquired.

The reflective layer 237 may be formed in a nano-sized lattice form C1 like C1 of FIG. 2.

The lower surface of the reflective layer 237 has an uneven structure like A1 and B1 of FIG. 2. In this case, the reflective layer 237 may be formed through a photolithographic process or an imprinting process.

The reflective layer 237 may be made of an alloy including at least one of aluminum (Al), copper (Cu), gold (Au), silver (Ag), chromium (Cr), tungsten (W), nickel (Ni), titanium (Ti), tantalum (Ta), molybdenum (Mo), and neodymium (Nd) or a carbon-based conductor such as carbon nanotube and graphene.

The prism sheet 235 is formed above the reflective layer 237 to increase front luminance of the light radiated by passing through the reflective layer 237.

The lower polarizer 236 is formed above the prism sheet 235 to polarize the light emitted by transmitting the prism sheet 235.

Accordingly, in the liquid crystal display according to the exemplary embodiment of the present disclosure, the light irradiated from the backlight unit 202 is blocked by the reflective layer 237 and as a result, the black matrix 211 has to block only the light inputted from the outside, such that the thickness thereof may be thinner.

In the liquid crystal display according to the exemplary embodiment of the present disclosure, a step of the color filter layer 212 may be decreased and the thickness of an overcoating layer 214 may become thinner or the overcoating layer 214 may be removed. Accordingly, in the liquid crystal display according to the exemplary embodiment of the present disclosure, absorptance of light may be reduced by the reduced thickness of the color filter layer 212 and transmittance of light may be improved.

In the liquid crystal display according to the exemplary embodiment of the present disclosure, the step of the color filter layer 212 is improved by the thin black matrix 211, such that a defect due to a rubbing defect in the process of forming the alignment layer 221 may be reduced, thereby improving productivity and reducing costs.

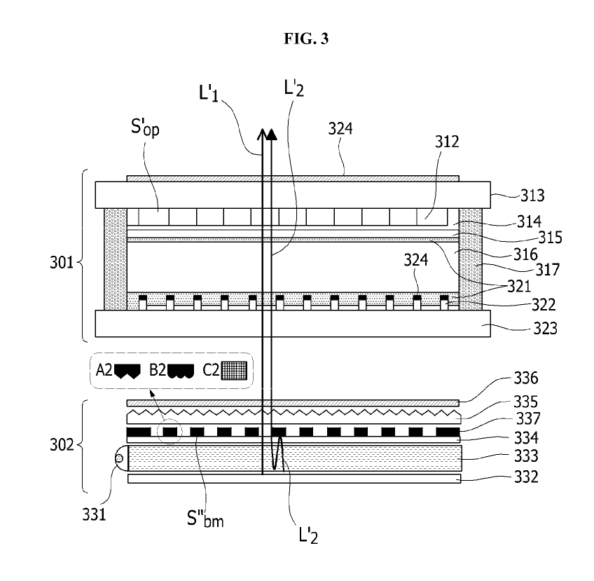

FIG. 3 is a cross-sectional view illustrating a schematic configuration of a liquid crystal display according to a second exemplary embodiment of the present disclosure.

Referring to FIG. 3, in the liquid crystal display according to the second exemplary embodiment of the present disclosure, the black matrix is removed and a color filter layer 312 all are configured by light transmitting regions S′ₒₚ.

In the liquid crystal display according to the second exemplary embodiment of the present disclosure, a resin black matrix 324 is disposed above a thin film transistor 322 of a TFT array substrate 323 to prevent a leakage current due to the light inputted from the outside.

Accordingly, in the liquid crystal display according to the exemplary embodiment of the present disclosure, a step of the color filter layer 312 may be decreased, the thickness of an overcoating layer 314 may become thinner or the overcoating layer 314 may be removed, and the absorptance of light may be reduced by the reduced thickness of the color filter layer 312 and the transmittance of light may be improved.

In the liquid crystal display according to the exemplary embodiment of the present disclosure, the light is selectively irradiated to each pixel by a reflective layer 337, such that a color mixed phenomenon due to the adjacent pixels may be prevented.

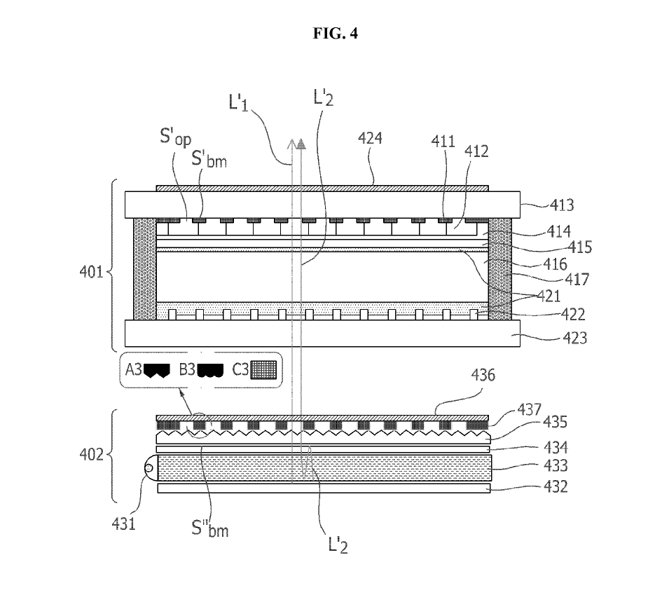

FIG. 4 is a cross-sectional view illustrating a schematic configuration of a liquid crystal display according to a third exemplary embodiment of the present disclosure.

Referring to FIG. 4, in the liquid crystal display according to the third exemplary embodiment of the present disclosure, a reflective layer 437 is disposed between a prism sheet 435 and a lower polarizer 436.

Accordingly, the light irradiated from a light source 431 is collected in a light guide plate 433 to pass through a diffusion sheet 434 and the prism sheet 435 which are optical sheets and then, be irradiated to the black matrix region S′_{bm} of a color filter substrate 413. Light L′₂ irradiated to the black matrix region S′_{bm} of the color filter substrate 413 is reflected toward the light guide plate 433 and a reflective plate 432 of the bottom thereof from a light blocking region S″_{bm} of a reflective layer 437 and a path of the light is changed and then, the Light L′₂ is collected in the light transmitting region S′ₒₚ of a liquid crystal panel 401. As a result, the lights transmitting the liquid crystal panel 401 are L′₁ and L′₂, such that the amount of light of the liquid crystal display may increase and high luminance may be acquired.

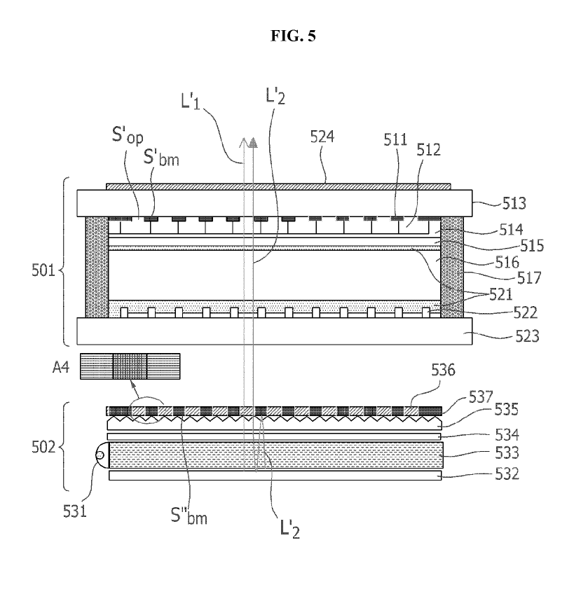

FIG. 5 is a cross-sectional view illustrating a schematic configuration of a liquid crystal display according to a fourth exemplary embodiment of the present disclosure.

Referring to FIG. 5, in the liquid crystal display according to the fourth exemplary embodiment of the present disclosure, a reflective layer 537 is formed in a lower polarizer 536.

The reflective layer 537 has patterns which are vertical to a transmitting axis of the lower polarizer 536 and has the same region as or a larger region than a black matrix 511 of a color filter layer 512.

The reflective layer 537 may be formed in a lattice form at the position corresponding to the black matrix region S′_{bm} like A4 of FIG. 5 and have nano-sized patterns in order to reflect all visible rays.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A liquid crystal display, comprising:
a liquid crystal panel; and
a backlight unit disposed below the liquid crystal panel and irradiating light to the liquid crystal panel,
wherein the backlight unit includes a reflective layer increasing an amount of light irradiated to the liquid crystal panel.

2. The liquid crystal display of claim 1, wherein the backlight unit includes:
a light source generating light;
a light guide plate collecting the light irradiated from the light source;
a reflective plate formed below the light guide plate;
a diffusion sheet formed above the light guide plate to acquire uniform luminance according to a viewing angle;
a prism sheet formed above the diffusion sheet to increase front luminance of light irradiated by passing through the diffusion sheet; and
a lower polarizer formed above the prism sheet to polarize the light emitted by transmitting the prism sheet,
wherein the reflective layer is formed between the diffusion sheet and the prism sheet and reflects the light emitted from the light guide plate to the reflective plate to change the path of light.

3. The liquid crystal display of claim 1, wherein the backlight unit includes:
a light source generating light;
a light guide plate collecting the light irradiated from the light source;
a reflective plate formed below the light guide plate;
a diffusion sheet formed above the light guide plate to acquire uniform luminance according to a viewing angle;
a prism sheet formed above the diffusion sheet to increase front luminance of light radiated by transmitting the diffusion sheet; and
a lower polarizer formed above the prism sheet to polarize the light emitted by passing through the prism sheet,
wherein the reflective layer is formed between the prism sheet and the lower polarizer and reflects the light emitted from the light guide plate to the reflective plate to change the path of light.

4. The liquid crystal display of claim 1, wherein the backlight unit includes:
a light source generating light;
a light guide plate collecting the light irradiated from the light source;
a reflective plate formed below the light guide plate;
a diffusion sheet formed above the light guide plate to acquire uniform luminance according to a viewing angle;
a prism sheet formed above the diffusion sheet to increase front luminance of light irradiated by transmitting the diffusion sheet; and
a lower polarizer formed above the prism sheet to polarize the light emitted by transmitting the prism sheet,
wherein the lower polarize includes a reflective layer reflecting the light emitted from the light guide plate to the reflective plate to change the path of light.

5. The liquid crystal display of claim 1, wherein the reflective layer is formed in a lattice form having a nano size.

6. The liquid crystal display of claim 1, wherein the bottom of the reflective layer has an uneven structure.

7. The liquid crystal display of claim 1, wherein the reflective layer is formed by a photolithographic process or an imprinting process.

8. The liquid crystal display of claim 1, wherein the reflective layer is made of an alloy including at least one of aluminum (Al), copper (Cu), gold (Au), silver (Ag), chromium (Cr), tungsten (W), nickel (Ni), titanium (Ti), tantalum (Ta), molybdenum (Mo), and neodymium (Nd) or a carbon-based conductor such as carbon nanotube and graphene.

9. The liquid crystal display of claim 1, wherein the liquid crystal panel includes:
a color filter substrate and a thin film transistor (TFT) array substrate opposed to each other and having an electrode generating an electric field at least one side thereof;
a plurality of gate lines and a plurality of data lines vertically and horizontally arranged on the TFT array substrate to define a pixel area;
a plurality of thin film transistors formed a cross region of the plurality of gate lines and the plurality of data lines;
a color filter layer formed below the color filter substrate; and
a liquid crystal layer formed between the color filter substrate and the TFT array substrate.

10. The liquid crystal display of claim 9, wherein the liquid crystal panel further includes a black matrix formed above the interface of the color filter layer to block light.

11. The liquid crystal display of claim 9, wherein the liquid crystal panel further includes a resin black matrix formed above each of the thin film transistors to block light.
